(19) United States
(12) Patent Application Publication
(10) Pub. No.: US 2005/0115174 A1
(43) Pub. Date: Jun. 2, 2005

(54) Separating wall

(76) Inventor: Hubert Elmer, Innsbruck (AT)

Correspondence Address: COHEN, PONTANI, LIEBERMAN & PAVANE, 551 FIFTH AVENUE, SUITE 1210, NEW YORK, NY, 10176, US

(21) Appl. No.: 10/509,822

(22) PCT Filed: Oct. 23, 2003
(86) PCT No.: PCT/EP03/11751

(30) Foreign Application Priority Data
Oct. 25, 2002 (DE) 20216557.4

(51) Int. Cl. E06B 3/00

(52) U.S. Cl. 52/204.5

(57) ABSTRACT

Separating wall made of glass with frameless side parts which are held at the base and at a top structure, at least one frameless transom which is held at the two side parts and at the top structure, and at least one leaf which is rotatably arranged below the transom and between the two side parts. The leaf is rotatably supported exclusively at the transom and at the base by means of fitting parts, and the transom and the side parts are fastened to one another and to the top structure and the base without the fittings.

The invention is directed to a partition or separating wall according to the preamble of claim 1.

The brochure “DORMA Universal” (issue of 12/93) discloses glass separating walls in which door leaves which are rotatable by means of fittings are arranged between side parts below transoms or top lights, as they are called. The fittings unite the rotatable bearing support of the door leaf and the connection to the transom and to the corresponding side part in a structural component group. This functional combination creates a disadvantageous dependency with respect to the design of the separating wall because the large quantity of possible angular positions between the glass elements can only be realized with an unprofitably large quantity of different fitting variants.

The mounting of fittings of this type is basically uneconomical and time-consuming because the fitting parts must be mounted and aligned with respect to one another in an exact manner and without tension due to the sensitivity of the glass material. Further, visible fittings conflict with the general aim of products which blend into their surroundings. Further, it is disadvantageous that the fittings make it difficult to clean the glass surfaces.

Therefore, it is the object of the present invention to provide a separating wall in which the stationary glass elements are arranged at or fastened to one another independent from the construction of the fittings for glass elements that are rotatably arranged in the separating wall.

This object is met through the characterizing features indicated in claim 1. Advantageous developments of the separating wall are indicated in the subclaims.

By separating the function of the rotatable bearing support and from that of the fastening of glass elements to one another, very different and complex separating wall structures can be realized without limitations. In the simplest arrangement, a completely straight line is formed. Further, depending on the quantity of glass elements that are used, a great many angular arrangements can be realized. Therefore, a system of this kind can be used in multifaceted ways from a simple separating wall to a complex separating wall landscape.

A separating wall system of the type mentioned above makes it possible to construct, plan and arrange the glass elements within the framework of a grid system because the glass elements are no longer joined by fittings. The arrangement of the glass elements can accordingly be planned without restrictions and can easily be tailored to local conditions and needs.

The separating wall is advantageously made to blend in visually with its surroundings. Cleaning is considerably simplified because dirt edges of fittings are substantially reduced and a plane glass front is formed. A separating wall of this kind is constructed using frameless glass so that expenditure on framing work is also eliminated. The separating wall comprises a plurality of side parts which are arranged between a base and a top construction, rotatably arranged leaves being located between these side parts in variable positions below transoms.

The rotatable leaf is supported, e.g., on the top at the transom and at the bottom at the base. By eliminating fastening to an adjacent glass element, the fitting is substantially reduced and simplified. Further, individual parts which are identical to a great extent are used. Accordingly, fastening and support of a rotatable leaf below a transom is provided in a simple and economical manner and the quantity of individual parts and arrangement of the fittings are optimized. The mounting and adjustment of the fittings is considerably simplified and can be prepared in the factory to a great extent. In an advantageous construction, the leaf has no additional add-on parts such as door handles or locks, resulting in an extensively continuous glass front.

The glass elements such as transoms and side parts are fastened to one another without fittings by means of a permanently elastic mass which connects the longitudinal abutting edges of the transom to the respective abutting edge of the side part in a frictional engagement. The transom and side parts are fixed at the base side and at the top side by sections or profiles arranged at the base side and top side, also using the permanently elastic mass. The profiles are preferably U-shaped. This type of fastening of the glass elements makes it possible to realize very different separating wall structures without restrictions with regard to the angular positions of individual glass elements relative to one another.

The compound is permanently elastic in order to ensure that the fastening is resistant to vibrations resulting from operation. Acrylic or silicone materials are advantageously suitable for this purpose, particularly in that methods of processing these materials are sufficiently well known.

The glass used for separating wall landscapes of this type does not contain bore holes since no fittings are used.

As an additional protective measure against vibrations and in order to stiffen the glass elements, horizontally extending stiffening elements in the form of glass struts can be fastened to the surface of the glass elements so as to project perpendicular thereto. Tle glass struts preferably stand on the ground or base and are likewise fastened by means of the permanently elastic mass. Also, in this connection, a uniform and visually appealing front is provided through the use of glass.

Further details, characteristic features and advantages of the invention are indicated in the following description of preferred embodiment examples with reference to the drawings.

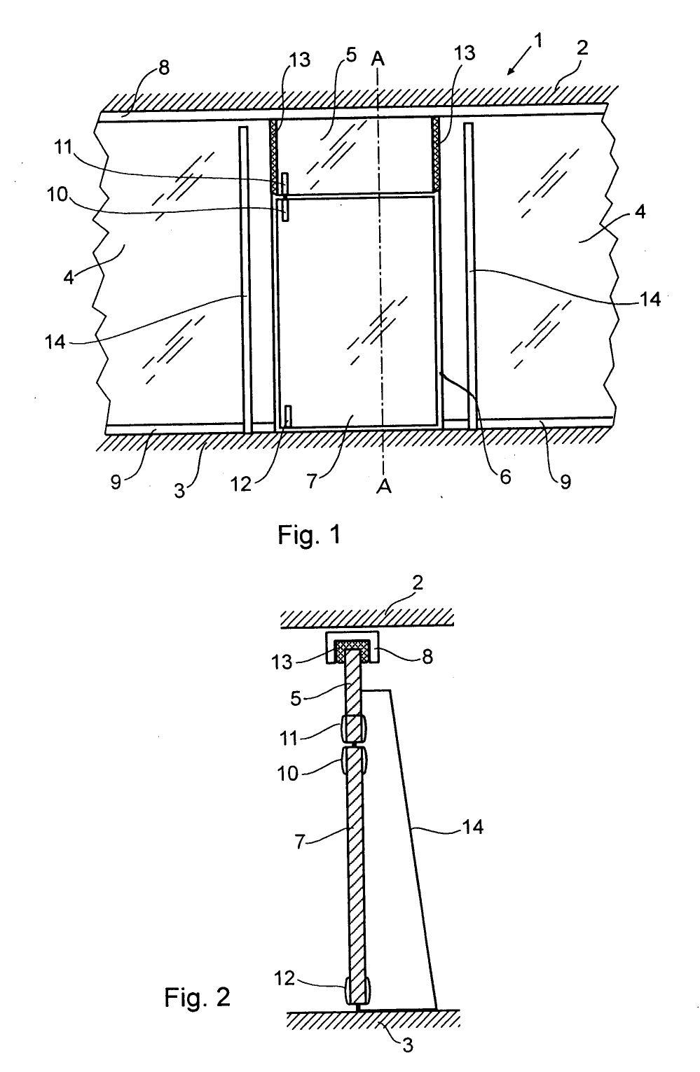

FIG. 1 shows a front view of a partial area of a separating wall;

FIG. 2 shows a cross section through the separating wall according to line A-A in FIG. 1;

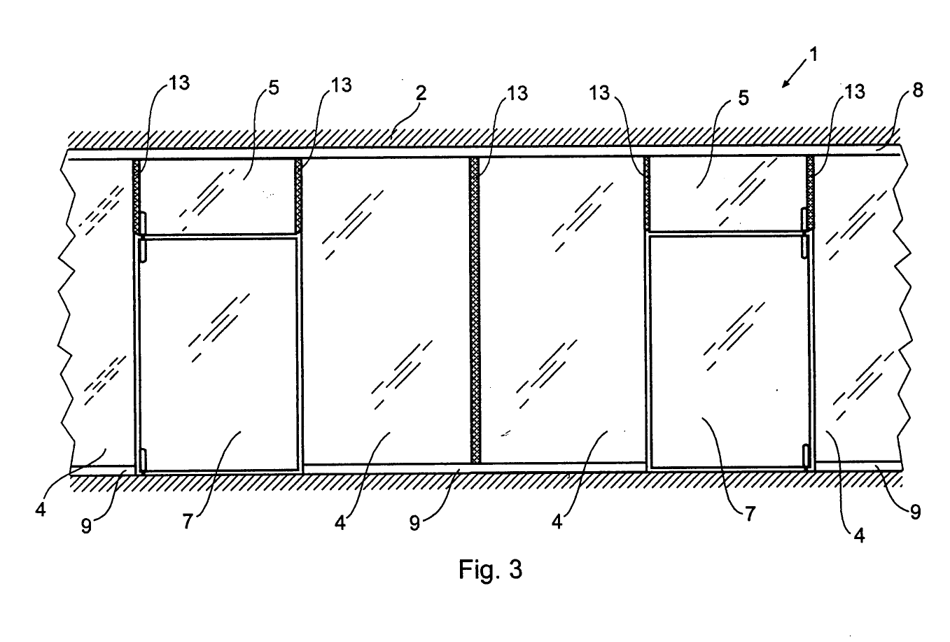

FIG. 3 shows a schematic front view of a complex separating wall configuration;

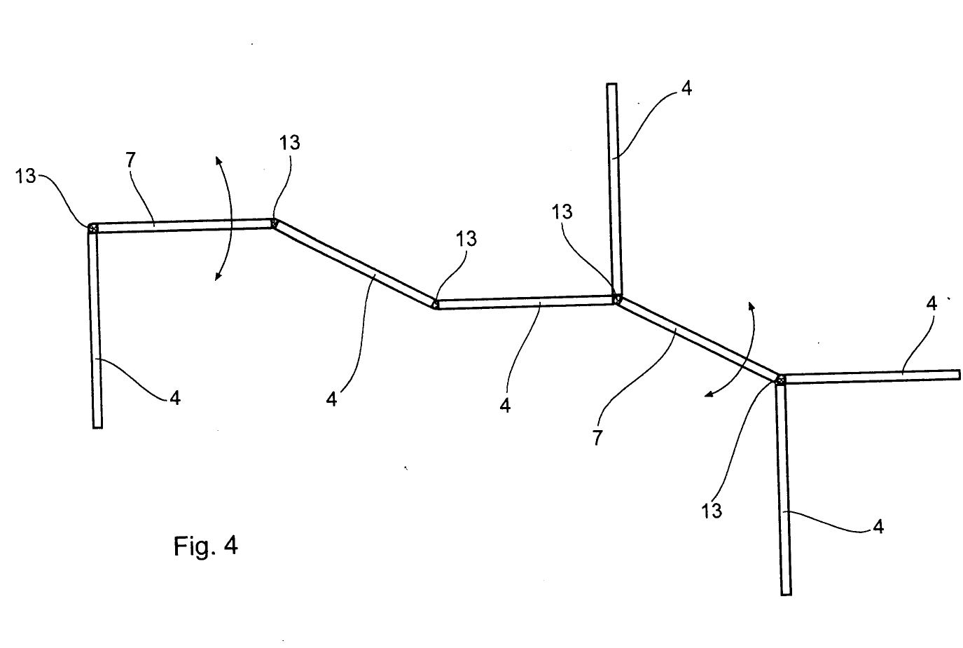

FIG. 4 shows a schematic top view of a complex separating wall.

A first embodiment example of a separating wall 1 according to the invention is shown in section in FIGS. 1 and 2. The separating wall 1 extends between a top construction 2 and a base 3. The separating wall 1 comprises different frameless glass elements which are constructed as side parts 4 on the one hand and constitute a transom 5 arranged between the side parts 4 on the other hand. A transom 5 of this kind extends only in the upper region of a separating wall 1, so that a passage 6 is formed below the transom 5 and between the side parts 4. A leaf 7 made of glass is rotatably supported in this passage 6. A continuous, preferably U-shaped profile 8 extends at the top construction 2, while two U-shaped profiles 9 extend at the base.

The leaf 7 is rotatably supported at the top at the transom 5 and at the bottom at the base 3. A symmetrically constructed fitting part 10 which cooperates with a complementary fitting part 11 arranged at the transom 5 is fastened to the leaf 7 at the top. A bearing pin of one fitting part cooperates with a bearing bush of the other fitting part. Further, a symmetrically constructed fitting part 12 which cooperates with a bearing arranged in the base 3 is fastened to the leaf 7 at the bottom. A door closer, not shown, which forms the bottom bearing support of the leaf 7 is preferably recessed into the base 3, so that the leaf 7 closes automatically after being opened manually. In the construction shown in the drawing, the leaf 7 has no additional add-on parts such as a door handle or locks, so that an extensively continuous glass front is formed.

The transom 5 is connected at the longitudinal abutting edges in a frictional engagement with the respective longitudinal abutting edge of the side parts 4 by means of a permanently elastic mass 13. Further, the transom 5 is fastened in a frictional engagement with the transverse, upper abutting edge in the profile 8 on the top by means of the permanently elastic mass 13. The two side parts 4 are fastened in the corresponding profiles 8, 9 on the base side and on the top side likewise by means of the permanently elastic mass 13.

Further, stiffening elements 14 can be arranged on the side parts 4 and fastened by means of the permanently elastic mass 13 so as to project perpendicularly and extend horizontally. The stiffening elements 14 are constructed as glass struts and stand on the base.

FIGS. 3 and 4 show different complex separating wall constructions within the framework of the idea according to the invention. The separating walls 1 comprise a plurality of side parts 4, transoms 5 and leaves 7 which have a uniform grid dimension, so that many different separating wall shapes can be realized with these glass elements. In particular, the embodiment example in FIG. 4 shows that the glass elements can be arranged at many different angles relative to one another by means of fastening without fittings.

The preceding description of the embodiment examples serves for purposes of illustration only and not to limit the invention. Various changes and modifications are possible within the framework of the invention without departing from the scope of the invention and its equivalents.

Reference Numbers
1 separating wall
2 top construction
3 base
4 side part
5 transom
6 passage
7 leaf
8 profile
9 profile
10 fitting part
11 fitting part
12 fitting part
13 permanently elastic mass
14 stiffening elements

1-9. (canceled)

10. A glass separating wall comprising:
a pair of frameless side parts mounted between a top structure and a base;
a frameless transom between the side parts, the transom being held by the side parts and the top structure; and
at least one rotatable leaf between the side parts below the transom, the leaf being rotatably supported exclusively at the transom and the base by fittings,
wherein the side parts and the transom are fastened to one another and to the top structure and the base without the fittings which support the rotatable leaf.

11. The glass separating wall according to claim 10 wherein the side parts, the transom, and the leaf have a uniform grid dimension.

12. The glass separating wall according to claim 10 wherein the side parts, the transom, and the leaf are arranged in a common plane.

13. The glass separating wall according to claim 110 wherein the leaf has a top and a bottom, said fittings comprising complementary fitting parts at the top of the leaf and the transom, and complementary fitting parts at the bottom of the leaf and the base.

14. The glass separating wall according to claim 10 wherein the side parts and the transom each have longitudinal abutting edges, the abutting edges of the transom being connected to the abutting edges of respective said side parts.

15. The glass separating wall according to claim 10 further comprising a channel at each of the top structure and the base, the transom and the side parts engaging in the channels.

16. The glass separating wall according to claim 15 further comprising a permanently elastic mass frictionally engaging the transom to each of the side parts, and frictionally engaging the transom and each of the side parts in the charmers.

17. The glass separating wall according to claim 16 wherein the permanently elastic mass is made of at least one of silicone and acrylic.

18. The glass separating wall according to claim 10 further comprising vertically oriented stiffening elements supported on the base and arranged against the side parts perpendicularly to the side parts.
